(19) United States
(12) Patent Application Publication
(10) Pub. No.: US 2026/0211557 A1
(43) Pub. Date: Jul. 23, 2026

(54) NODE BASED ADDRESSING IN A STORAGE DEVICE

(71) Applicant: Micron Technology, Inc., Boise, ID (US)

(72) Inventors: Binbin Huo, Sauerlach (DE); Zoltan Szubbocsev, Santa Clara, CA (US); Nicholas T. Heath, Pittsboro, NC (US)

(21) Appl. No.: 19/451,961

(22) Filed: Jan. 16, 2026

Related U.S. Application Data
(60) Provisional application No. 63/748,737, filed on Jan. 23, 2025.

(51) Int. Cl. G06F 3/06

(52) U.S. Cl. CPC G06F 3/0616; G06F 3/0631; G06F 3/0659; G06F 3/0679

(57) ABSTRACT

System and techniques for managing block addresses in a memory device are described herein. A request for the memory device to perform an operation can include a node identifier. The memory device can access a node based on the node identifier and identify a physical block in the memory device from a reference to the physical block stored in the node. The memory device can then perform the operation using the physical block as identified from the node.

### PRIORITY APPLICATION

This application claims the benefit of priority to U.S. Provisional Application Ser. No. 63/748,737, filed Jan. 23, 2025, which is incorporated herein by reference in its entirety.

### TECHNICAL FIELD

Embodiments described herein generally relate to computer storage devices and more specifically to node based addressing in a storage device.

### BACKGROUND

A computer storage device is hardware used to store data. It keeps data for use in computing systems. It allows data to be stored and retrieved. Examples of storage devices include disks, drives, flash storage devices, solid-state drives, and memory cards. Flash storage devices use non-volatile memory to store data electronically. Other types of storage devices are magnetic tapes and optical media. Storage devices connect to the computer system and interact with the processing unit and memory to facilitate data management.

Block addressing is a technique used to manage data storage and retrieval by dividing the storage medium into fixed-size blocks. Each block is assigned a unique address, allowing the system to reference specific locations within the storage device. When a read or write operation is performed, the operating system or storage controller sends a request to the device, specifying the block address where the data is to be stored or retrieved. This method optimizes data access by minimizing the need for sequential data processing, enabling random access to data stored in different locations on the device. Block addressing is used in various storage technologies, including hard drives, solid-state drives, and flash storage. It is a key feature in file systems and databases to manage large datasets efficiently.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for node based addressing in a storage device, according to an embodiment.

FIG. 2 illustrates component interaction, according to an embodiment.

FIG. 3 illustrates a flow between components, according to an embodiment.

FIG. 4 illustrates a flow diagram of an example of a method for node based addressing in a storage device, according to an embodiment.

FIG. 5 is a block diagram illustrating an example of a machine upon which one or more embodiments may be implemented.

### DETAILED DESCRIPTION

Flash storage devices have a physical addressing scheme that is different from many other types of storage due to the way in which flash devices are written and erased; there is no concept of overwriting. Generally, the smallest physical unit that can be written is a page and the smallest physical unit that can be erased is an erase block which includes several (e.g., ten) pages. To modify data already written to a page generally involves writing the data to a new page and marking the old page for garbage collection. Garbage collection is a process to free blocks (e.g., usually closed blocks that do not have space for writing new data) so that the blocks can be used for writing again. If all of the data on the block is invalid, then garbage collection erases the block and enables the block to be written to again. If the block has some valid data, then garbage collection moves the valid data to an open block (e.g., a block with space for writing new data) and then erases the block being collected. This manipulation is part of flash management and can create a variety of complexities not found in other devices, such as magnetic hard drives.

Due to the physical limitations of flash storage devices, Logical-to-Physical (L2P) mapping tables are often used to manage translations between logical blocks used by the host system and the physical storage locations on the flash medium, called physical blocks. These physical blocks need not be, and often are not, the same as the erase blocks noted earlier. The host interacts with the flash storage device using logical block addresses (LBAs) for read and write operations, treating the storage as a sequence of uniform blocks. When data is moved from one physical block to another—such as during garbage collection—the flash storage controller updates the L2P table such that the logical block address now points to the new physical block address. In this way, flash maintenance operations can continue without impacting how the host interacts with the data. These maintenance operations include the garbage collection mentioned earlier, as well as wear leveling and bad block management, among others.

The physical nature of flash storage device operations does lead to other performance issues not found in different types of storage media. For example, the storage elements of flash devices—often called floating gate memory cells—physically degrade with reads, writes, and especially erasures. This means that there are generally a finite number of times any given memory cell can be used. This metric may be expressed as Terabytes Written (TBW) over the entire device. Moreover, many of the maintenance operations include writing data several times after receiving the data from the host. For example, data can be written to a fast low-density block formatted for single-level cell (SLC) encoding and then, behind the scenes, written to a higher density multi-level cell (MLC) formatted block for long term storage. Other additional writes can include those associated with garbage collection. These additional writes represent a Write Amplification Factor (WAF), and not only consume resources of the flash storage device or controller but can also reduce the lifespan of the flash storage itself.

A variety of techniques to reduce WAF, to improve TBW, or to increase other input-output (I/O) performance have been tried with flash storage devices. Some of these techniques include Zoned Storage (ZNS)—such as Zoned Universal Flash Storage (UFS), Data Streams (DSS), Flexible Data Placement (FDP), or Key-Value (KV) storage. Many of these are attempts to optimize data management or performance. However, these techniques have limitations that prevent them from being universally applicable, particularly in embedded systems or mobile device (e.g., smartphone) applications that involve diverse application workloads, varying data access patterns, or stringent performance requirements that demand more flexibility and efficiency than these techniques offer. Additionally, many of these techniques place a significant burden on host-side application management of the data, which limits adoption and applicability across different device ecosystems. For example, ZNS requires sequential writes from the host, making ZNS impractical for applications that cannot comply with this constraint. DSS and FDP provide limited contextual information (e.g., data type), which is insufficient for storage systems to manage data efficiently at a granular level. KV storage is primarily designed for databases and data centers with a focus on key-value pair management, making KV storage ill-suited for the embedded world, particularly in mobile devices, where resource constraints and real-time processing demands are prevalent.

To address the issues of current flash storage management, such as reducing WAF and increasing TBW, as well as providing a flexible technique suited to different workloads and device needs, file node block addressing (FNBA) can be used. Here, an index node (inode) like structure is exposed to the host rather than logical blocks, such that the host uses a node identifier (ID) to reference a data structure into which physical block addresses are managed by the flash storage controller. In inode based file systems, the same inode ID for a file can be used by the flash storage device, along with the offset and length read or write semantics to provide a file system level correspondence between the data of the file system and the storage structure in the flash storage device. With the additional metadata available to the file system, and this correspondence to the storage device, the storage device can more effectively manage the physical blocks to, for example, co-locate blocks for the same file on the same erase blocks, helping to reduce WAF and thus increase TBW. Additional details and examples are provided below.

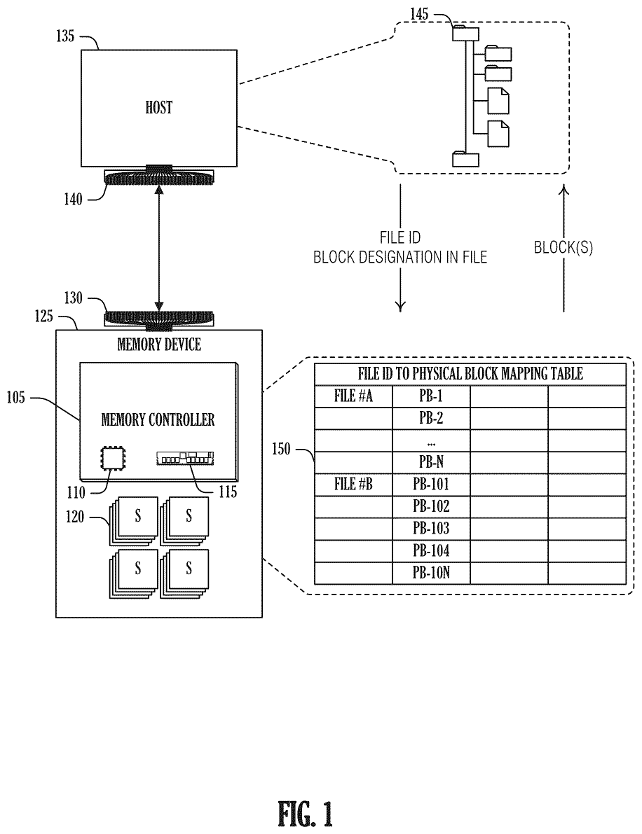

FIG. 1 is a block diagram of an example of an environment including a system 105 (e.g., a memory controller) for node based addressing in a memory device 125, according to an embodiment. The system 105 includes processing circuitry 110 and memory 115. The memory 115 is generally used to maintain running state information for the system 105 that is usually discarded between system power cycles or restarts. The system 105 is connected to storage 120 (e.g., power-stable storage such as a hard drive, solid state drive, etc.). In an example, the storage 120 is flash storage. The memory 115 and the storage 120 are both forms of computer readable media. The processing circuitry 110—or software residing in the memory 115 or storage 120 executing on the processing circuitry 110—configure the system 105 to perform various operations when running.

As illustrated, the memory device 125 (e.g., and the system 105) include an interface 130 configured to send or receive commands, data, or other information from other components, such as the host 135. The host 135 also has a corresponding interface 140 to communicate with the memory device 125. The host 135 is computational hardware that provides data to and consumes data from the memory device 125. In many computer systems, the host 135 is a central processing unit (CPU) or other processor. However, any component capable of communicating to the memory device 125 via the interface 130 can be considered the host 135.

As noted above, traditional interactions between the host 135 and a flash storage device communicate logical block addresses over the interface 130 that the memory device 125 would then convert to physical block addresses to retrieve data from the storage 120 for the host 135. Often, when a request (e.g., a read request) is received by the system 105 from the host, the request includes a logical block address. The system 105 can reference the L2P table from the memory 115 to locate the physical block address in the storage and then retrieve the data at that physical block address. Often, the L2P table is larger than the memory 115. In these cases, the portion of the L2P table that contains the logical block address is located from the storage 120 and loaded into the memory to lookup the corresponding physical block address.

In contrast to these traditional L2P correspondences, the system 105 implements a node and block (NaB) 150 correspondence similar to file system inodes. An inode is a data structure that includes some metadata (e.g., owner, last access, file type, etc.) as well as a fixed size list of block addresses. The block addresses can refer to physical block addresses or to other inodes, enabling more blocks to be allocated to a file than are available from the fixed size list of any given inode. The system 105 employs a similar data structure—the NaB 150—in place of the L2P tables of traditional flash storage devices, however, the level and extent of metadata stored or handled by the system 105 can be less than that of the inodes in the file system 145. The NaB 150 uses “node” in the network sense whereby nodes are connected to each other (e.g., a node can refer to another node) or to blocks. Other names for the node based addressing described herein can include indirect block addressing, group addressing of blocks, filesystem component (e.g., blocks in a file) addressing, or filesystem object identifier addressing, among others, depending upon the specific identification technique used for nodes.

The use of an inode like NaB 150 correspondence by the system 105 provides several advantages over the typical L2P block management model. For example, the node ID of the system 105 can be the same as the inode ID from the file system 145, providing a correspondence between the file in the file system 145 and the file in the storage 120. This correspondence provides information to the system 105 to better handle block management in the storage 120, such as where the blocks are stored, how they are garbage collected, etc. For example, if the file is a video file, it is less likely that the file will be overwritten often. Thus, the system 105 can be configured to co-locate the blocks together to fill erase blocks. This can help reduce garbage collection operations, reduce WAF, and increase TBW. Conversely, if the file is a temporary file, blocks can be located in erase blocks with many invalid blocks such that an inevitable garbage collection operation to reclaim those erase blocks also erases the temporary file.

To implement NaB addressing in the storage 120, the processing circuitry 110 is configured to receive (e.g., via the interface 130) a request to perform an operation on data of the storage 120 (e.g., from the host 135 via the interface 140). This request includes a node ID. The node ID corresponds to a node in the NaB 150, such as the illustrated file #A. In an example, the node ID is a concatenation of a file system ID for the file system 145 and an inode ID of the file system 145. In this example, there is a one-to-one correspondence between the node ID and the file system object (e.g., file, directory, etc.) in the file system 145. This is a convenient arrangement because inode IDs are unique within a given file system but are not guaranteed to be unique across file systems. Thus, concatenating the file system ID and the inode ID provides a unique ID for the node in the NaB 150. Further, there is an unambiguous correspondence between the node ID and the inode object in the file system 145, enabling efficient management of the node based on the file from the host 135 or the system 105.

In an example, the node ID is a Universally Unique Identifier (UUID). In this example, a node ID that is universally unique—within the definition of UUID—enables reference to the node across file systems (e.g., across hosts) without changing the node ID. This entails greater management by the host 135 because the UUID of the node is managed by the file system 145 but can reduce management by the system 105 because the node ID does not need to change if the corresponding file is moved to another file system.

In an example, the request includes an offset. This example illustrates the request for a block that is not the first block in the node. Using a traditional L2P table, the request would simply provide the logical block address desired. However, with the NaB 150, the node ID refers to the data structure that then contains the physical block addresses. Whereas all blocks referred to in the node can be returned with the request based on the node ID, the offset enables a subset of these blocks to be specified. For example, if only the fourth block is desired, then the offset is three in an indexing scheme that starts at zero.

In an example, the request includes a length. This can combine with the offset mentioned above to specify a subset of the node blocks by a starting position, the offset, and a number of blocks identifying the length. These can be combined in several ways to provide file system like access to the physical blocks via the single request. Because this arrangement mirrors that used to access a file system object in the file system 145, the result can be more efficient, with fewer requests needed than in the traditional L2P management model.

In an example, the request includes a type of write. In an example, the type of write is “TEMPORARY.” Here, the ability to correspond file type with the node enables varying management of blocks in the storage 120 by the system 105. As noted above, temporary files are usually short lived, and thus will be invalid soon after use. In this situation, the processing circuitry 110 can allocate physical blocks to the node that are likely to be erased soon. These blocks can include those in an erase block that is close to passing thresholds for garbage collection because the erase block already has several invalid blocks. Or, for example, a more robust SLC encoded erase block can be used for the physical blocks of the node. In contrast, other file types in the write can provide other hints for the processing circuitry on how to handle the block allocation. Files likely to be mostly static, such as postscript files, hypertext files, or video files can be allocated together to reduce the likelihood that the erase block will be erased. Moreover, striping, for example, across die in the flash storage can be used to increase read accesses in certain hardware configurations. These behaviors by the system 105 based on the file type can improve read or write performance, reduce WAF, and increase TBW over traditional techniques.

The processing circuitry 110 is configured to access a node in the NaB 150 based on the node ID in the request. As noted above, the node ID can include the file system ID of the file system 145. In an example, accessing the node based on the node ID uses the node ID as an index to the NaB 150 data structure. However, other techniques, such as searching the NaB 150 (sequentially or otherwise) can be employed to locate the node in the NaB 150. As with L2P tables, the entire NaB 150 may not be able to fit in the memory 115. In these cases, the node ID can be used by the processing circuitry to first locate the portion of the NaB 150 that contains the node, load that portion of the NaB 150 into the memory 115, and then access the node from the portion of the NaB 150 loaded into the memory 115 using the node ID.

The processing circuitry 110 is configured to identify a physical block in the storage 120 from a reference to the physical block in the node. As illustrated, this can be physical block PB-101 for file #B in the NaB 150. In an example, where the request includes an offset, identifying the physical block includes accessing an array of physical block addresses from the node, and reading an address of the physical block at an index of the array corresponding to the offset. Here, using file #B and an offset of two as an example, the request specifies block PB-103. If there was a length of two in the request, then the request would specify physical blocks PB-103 and PB-104.

The processing circuitry 110 is configured to perform the operation specified in the request using the physical block as identified from the node in the NaB 150. Thus, if the request is a read, then the identified physical block, or blocks, are read from the storage 120. If the request is a write, then the data included in the request is written to the identified physical block or blocks in the storage 120. In an example, where the request includes a length, performing the request includes accessing an array of physical block addresses from the node, performing the operation on all physical block references at indices of the array between a first index corresponding to the physical block and a second index equal to the first index plus the length.

As mentioned before, the request can include a characterization of a file object during a write. This characterization can be used by the processing circuitry 110 to control how physical blocks are allocated to the node. In an example, wherein the request is a write of type “TEMPORARY,” performing the operation restricts the physical block to a buffer area of the storage device. In an example, the number of blocks allocated to the node are based on the file characterization (e.g., a file type). Thus, a video file can have more blocks allocated to the corresponding node than a text file, for example. In an example, physical block location in the storage can also be affected by the characterization. For example, some files can benefit from contiguous allocation in the storage 120 while other files can benefit from being striped across elements (e.g., die, packages, etc.) of the storage to provide redundancy or throughput performance. In an example, the encoding level of erase blocks can be selected based on file characterization in the write request. For example, files that are tolerant of write speed and include a lot of information can be encoded at higher levels (MLC, triple level encoding (TLC), etc.) to achieve greater storage density without impacting user experiences. Conversely, small temporary files that require quick writes can be allocated to SLC erase blocks.

The use of the NaB 150 instead of traditional L2P tables leads to slightly different approaches when gathering blocks for maintenance operations, such as garbage collection. Accordingly, in an example, the processing circuitry 110 is configured to detect a trigger to perform a garbage collection operation on the storage 120 that includes the physical block discussed earlier. The processing circuitry 110 is configured to access the array of physical block addresses from the node in the NaB 150 and allocate a set of physical blocks with a constraint (e.g., to be contiguous, striped, etc.) for members of the set of blocks in the storage 120. The processing circuitry 110 is configured to write data from physical blocks corresponding to the physical block addresses to the set of physical blocks. In this way, the movement of the node physical blocks that occurs during garbage collection follows the allocation constraints that were used when the blocks were originally written. In an example, the processing circuitry 110 updates the array of physical block addresses in the node of the NaB 150 with addresses corresponding to the new set of physical blocks to which the data was written.

When performing original file allocation (e.g., a first write to a file object) a node is assigned to the file in the NaB 150. Thus, the processing circuitry 110 is configured to receive a second request to write to the storage 120, the second request including a second node identifier. The processing circuitry 110 is configured to detect that the storage 120 (e.g., the NaB 150) does not have a second node that corresponds to the second node identifier, marking it as a new file (e.g., node allocation). In this example, the processing circuitry 110 is configured to allocate a set of physical blocks based on the second request and create the second node. Creating the second node includes storing addresses for the set of physical blocks in the array of the second node in the NaB 150 and recording an association between the second node and the second node identifier. The processing circuitry 110 is configured to then write data to the set of physical blocks to perform the request. In an example, allocating the set of physical blocks includes applying a constraint for members of the set of blocks based on the file characterization (e.g., type).

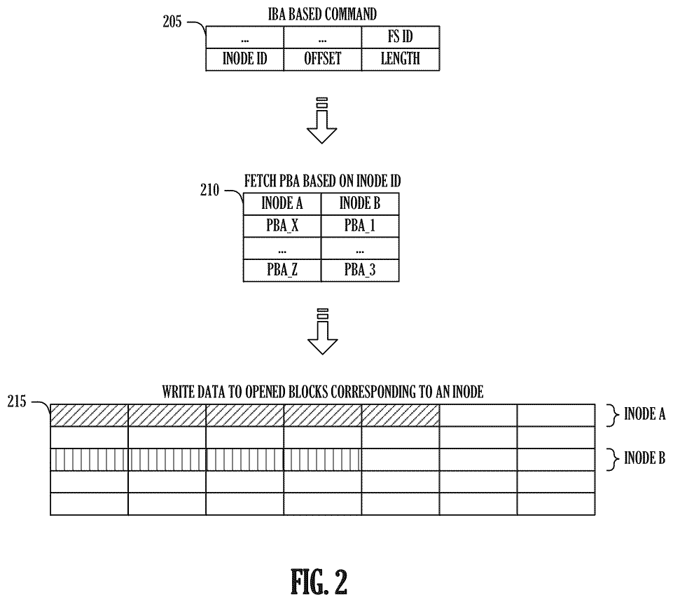

FIG. 2 illustrates component interaction, according to an embodiment. The illustrated components are a command 205 (e.g., from a host to a controller) that includes an inode ID, a file system ID (FS ID), an offset, and a length. The inode ID (e.g., and the FS ID) are used to retrieve part of an NaB 210 that includes the arrays of physical blocks referenced by the inode ID in the command 205. This array of physical blocks is then used to write or read the data from the storage 215.

Because the examples use the inode ID from a file system, the following is a short review of file system inodes, which differ from the nodes used in the NaB. An inode, which can also be referred to as an index node, are fundamental components of many file systems, serving as unique identifiers for file metadata, such as metadata about a file (e.g., owner, date created, size, etc) and an identification of the data blocks where file contents are stored. The following is a visual representation of an example of a file system inode:

| +−−−−−−−−−−−−−−−−−−−−−−−−−−−−−−−−−−−−−−−−−−−−+ | |
|---|---|
| \| Inode Structure \| | |
| +−−−−−−−−−−−−−−−−−−−−−−−−−−−−−−−−−−−−−−−−−−−−+ | |
| \| Inode ID : <Unique Identifier> \| | |
| \| File Type : <Regular File/Directory/Symlink/ ... > \| | |
| \| Permissions : <rwx−−−−−−> | \| |
| \| Owner UID : <User ID> | \| |
| \| Group GID : <Group ID> | \| |
| \| File Size : <Total Size in Bytes> | \| |
| \| Creation Time : <Creation Timestamp> | \| |
| \| Modification Time: <Modification Timestamp> | \| |
| \| Access Time : <Access Timestamp> | \| |
| +−−−−−−−−−−−−−−−−−−−−−−−−−−−−−−−−−−−−−−−−−−−−+ | |
| \| Direct Pointers: | \| |
| \| <Block Pointer 1> −> Data Block 1 | \| |
| \| <Block Pointer 2> −> Data Block 2 | \| |
| \| ... | \| |
| \| Indirect Pointer: | \| |
| \| <Block Pointer to Indirect Block 1> | \| |
| \| Double Indirect Pointer: | \| |
| \| <Block Pointer to Double Indirect Block> | \| |
| \| Triple Indirect Pointer: | \| |
| \| <Block Pointer to Triple Indirect Block> | \| |

+−−−−−−−−−−−−−−−−−−−−−−−−−−−−−−−−−−−−−−−−−−−−+

The direct pointers have a block address. The indirect pointer refers to another inode that includes block addresses, and the double indirect pointer refers to another inode that again refers to another inode before block addresses and so on.

In an example, the NaB node managed by the storage device controller does not include all the metadata illustrated above. Rather, the NaB node includes the block references such that the host, or other component, can specify blocks for reading or writing via a combination of the inode ID, an offset, and a length.

By eliminating the use of logical block addresses and using inode IDs and offsets directly to the storage device, the storage device can manage and organize the physical block allocations according to the restrictions or optimizations present within the storage device (e.g., defined in firmware, software, hardware, etc.). As noted above, this approach can facilitate sequential writing or enable garbage collection at the file-based level, enhancing system efficiency and performance.

This approach contrasts from traditional L2P models in several ways. For example, host access (e.g., software) does not provide logical block addresses in requests, but rather provides inode IDs (or other file identifiers) (e.g., and offsets or lengths) directly to the storage device. The storage device controller is also different in that the controller accepts these specifiers (e.g., inode ID, offset, or length) and translates the specifiers into physical block addresses. The controller can also be modified to perform sequential writing based on the inode and offset specified as well as support garbage collection at the file level, which could be more efficient than traditional block-level garbage collection.

By using the NaB node approach to physical block addressing, the technique simplifies storage architecture and improves performance. While different node ID schemes can be employed, using the already existing inode ID approach has several advantages. For example, consider inode uniqueness. Each file system that uses inodes has a set of inodes, stored in a common table, that are ensured to be unique within the file system. Thus, the combination of the file system ID (FS ID) and the inode ID provides a unique ID for NaB nodes across different file systems.

Inodes are reusable. Generally, when a file is deleted in a file system, the inode ID of the file is recycled into a pool of unused inodes, thus becoming available for reuse by the file system. In modern file systems, there can be a maximum number of 2\hat{ }32=4.3 billion inodes.

The following table illustrates some of the differences between NaB and L2P addressing described above. Here, “w/r” means “write or read.”

L2P versus NaB Addressing

| | | |
|---|---|---|
| w/r command contains | L2P | NaB |
| w/r command contains | Logical block address | Node ID (e.g., inode ID), |
| | (LBA) and access | file offset accessed, |
| | length | length |
| Storage device | Retrieve the associated | Retrieve the PBA by |
| behavior | physical block address | looking up the file |
| | (PBA) by searching | mapping table (e.g., |
| | the mapping in the | NaB) using the node ID |
| | L2P table | and offset |
| Write | Identify a new PBA | Consider two writing |
| | for LBA, where | techniques: for temporary |
| | various types of data | files, write sequentially |
| | will be combined | to buffer block, and for |
| | within the same | long-term files, write |
| | physical block | directly to respective |
| | | opened blocks |
| Garbage collection | At the block level, | At the file level, group |
| | there is no data | data with the same node |
| | reorganization. | ID |

Other things that can be stored in the node data structure in the NaB include specific block allocation hints or constraints definitions (e.g., location, encoding level, etc.) as noted above. Another aspect of identifying these constraints, aside from the file type or characterization described above, is data temperature. Data temperature refers to how often the data is accessed. Thus, a write temperature that is hot indicates that the data is written frequently, while cold indicates that the data is written to infrequently (e.g., such as static, write once, data). Similarly, a read temperature that is hot indicates that the data is frequently read. These data temperatures (referring to access frequency) are different than the physical temperature effects of reading from or writing to flash memory.

The use of the NaB node technique enables the storage device to operate on files without sophisticated management controls. Thus, for example, an entire file can be pre-fetched by the storage device via a simple storage of the node ID. Further, files can be copied by the storage device without the host having to recall block data and send it back to the storage device.

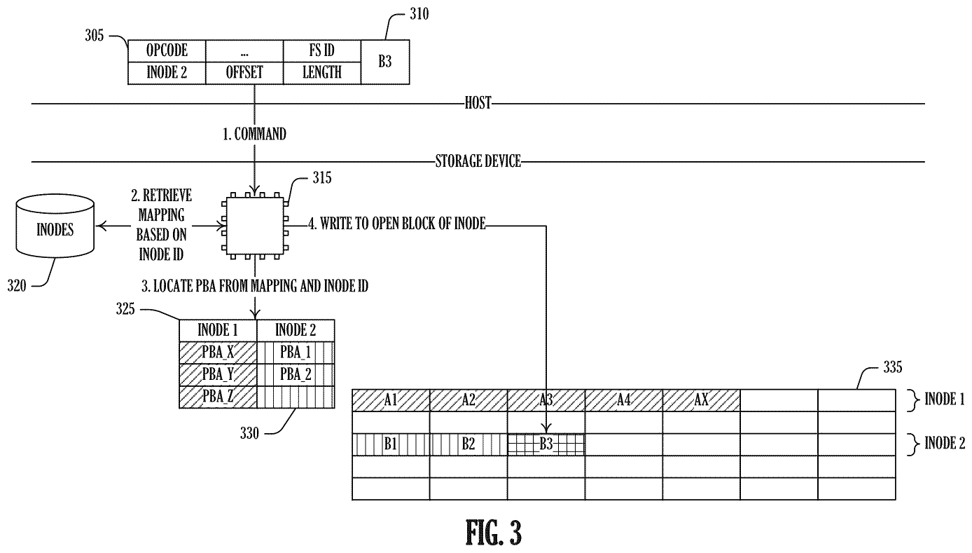

FIG. 3 illustrates a flow between components, according to an embodiment. As illustrated, a host is attempting to write a block B3 to the storage device. The host provides the command 305 that includes the opcode, WRITE, the node identifier, inode 2, a file system ID (FS ID), an offset, a length, and the data 310.

The command is transmitted to the controller 315 of the storage device. The controller 315 retrieves a mapping 325 of the node from a database 320. The controller then uses the mapping 325 and the data in the command 305 to locate an available physical block address 330 for inode 2. The controller 315 then writes the data 310 into the physical block in the storage 335 that corresponds to the available physical block address 330.

In an example, using a sequential ordering for node ID allocation by the controller 315 can reduce complexity when retrieving the mapping 325 from the database 320 based on the node ID. For example, the database 320 can be a table with sequentially stored node IDs. The table can include extents that are labeled with the node ID of the first node in the table. These can be sequentially inspected until the next extent node ID is greater than the node ID in the command 305. Other types of indexing, such as a binary search tree, B-tree, or other structure can also be used to facilitate quick retrieval of the mapping 325 from the database 320.

In an example, the host (e.g., software on the host) is configured to allocate inodes in a linear or sequential order. This technique optimizes storage 120 performance by reducing the load associated with extracting or managing a mapping table. For example, older files are assigned smaller node IDs, while newer files are given progressively larger node IDs, reflecting their order of creation. Here, when a file is deleted, its associated inode is reused for a newly created file, ensuring efficient utilization of available inodes and maintaining a consistent and organized structure within the file system 145. This approach helps streamline file operations and improves overall system performance.

In an example, the inode ID may change after certain events, such as when a snapshot is taken. Within the file system 145, taking a snapshot can lead to the creation of a new inode that represents a file state at the creation of the snapshot. When the snapshot is subsequently released, the file system 145 can either revert to the original inode or create a new one, resulting in a change in the inode ID. In an example, to maintain inode consistency, the host 135 file system 145 is configured to ensure a consistent file inode ID before and after the release of a snapshot. To accomplish this, in an example, the host 135 is configured to mount the snapshot, configure settings to prevent changes to the original inode ID, or add a flag in the file descriptor in the file system 145 that is, for example, shared with the memory device 125.

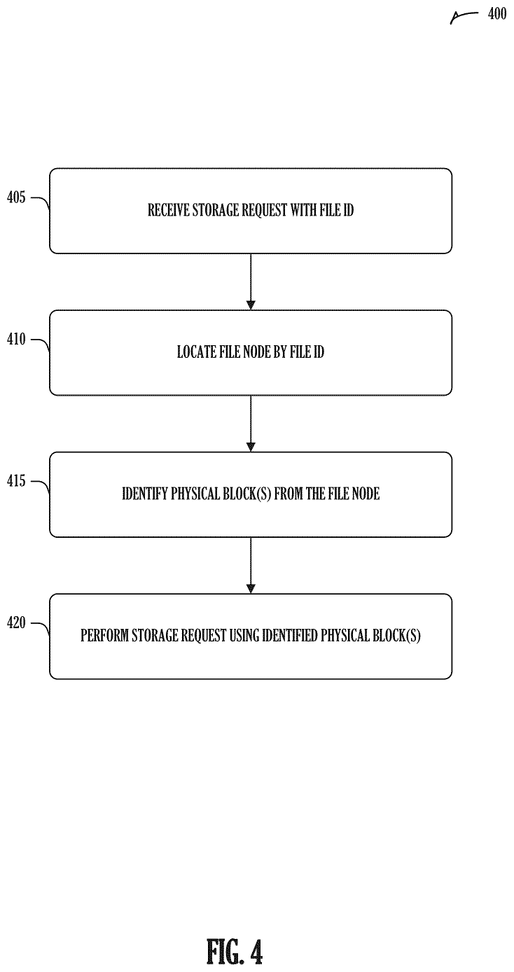

FIG. 4 illustrates a flow diagram of an example of a method 400 for node based addressing in a storage device, according to an embodiment. The operations of the method 400 are performed by computational hardware, such as that described above or below (e.g., processing circuitry).

At operation 405, a request to perform an operation on data of a storage device is received (e.g., from an interface of a controller). This request includes a node identifier. In an example, the node identifier is a concatenation of the file system ID and an inode ID of the file system. In an example, the node identifier is a Universally Unique Identifier (UUID). In an example, the request includes an offset. In an example, the request includes a length.

In an example, the request includes a type of write. In an example, the type of write is “TEMPORARY.”

At operation 410, a node is accessed (e.g., by the controller) based on the node identifier in the request. In an example, the node identifier includes a file system ID.

At operation 415, a physical block in the storage device is identified from a reference to the physical block in the node. In an example, where the request includes an offset, identifying the physical block includes accessing an array of physical block addresses from the node, and reading an address of the physical block at an index of the array corresponding to the offset.

At operation 420, the operation is performed using the physical block as identified from the node. In an example, where the request includes a length, performing the request includes accessing an array of physical block addresses from the node, performing the operation on all physical block references at indices of the array between a first index corresponding to the physical block and a second index equal to the first index plus the length. In an example, wherein the request is a write of type “TEMPORARY,” performing the operation restricts the physical block to a buffer area of the storage device.

In an example, the operations of the method 400 can include detecting a trigger to perform a garbage collection operation on storage of the storage device including the physical block. The controller can access an array of physical block addresses from the node and allocate a set of physical blocks with a constraint for members of the set of blocks to be contiguous in the storage device. The controller can then write data from physical blocks corresponding to the physical block addresses to the set of physical blocks. In an example, the controller can update the array of physical block addresses with addresses corresponding to the set of physical blocks.

In an example, the operations of the method 400 can include receiving a second request to write to the storage device. Here, the second request includes a second node identifier. The controller can then detect that the storage device does not have a second node that corresponds to the second node identifier. In this example, the controller can allocate a set of physical blocks based on the second request and create the second node. Creating the second node includes storing addresses for the set of physical blocks in an array of the second node and recording an association between the second node and the second node identifier. The controller can then write data to the set of physical blocks to perform the request. In an example, allocating the set of physical blocks includes applying a constraint for members of the set of blocks to be contiguous in the storage device.

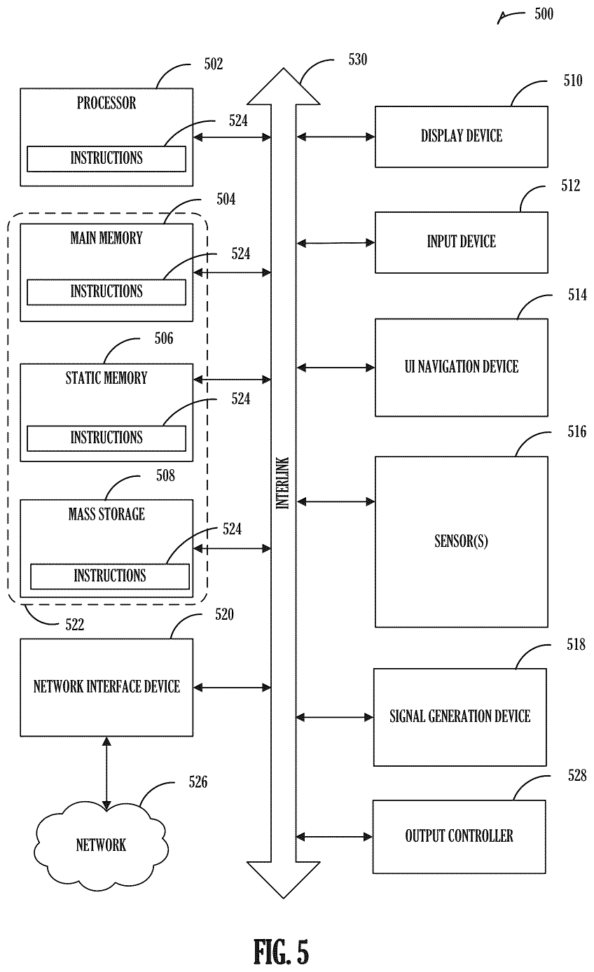

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for node based addressing in a memory device, the apparatus comprising: an interface configured to communicate to a device external to the memory device; and processing circuitry configured, when in operation, to: receive, via the interface, a request to perform an operation on data of the memory device, the request including a node identifier; access a node based on the node identifier in the request; identify a physical block in the memory device from a reference to the physical block in the node; and perform the operation using the physical block as identified from the node.

In Example 2, the subject matter of Example 1, wherein the request includes an offset.

In Example 3, the subject matter of Example 2, wherein, to identify the physical block, the processing circuitry is configured to: access an array of physical block addresses from the node; and read an address of the physical block at an index of the array corresponding to the offset.

In Example 4, the subject matter of any of Examples 1-3, wherein the request includes a length.

In Example 5, the subject matter of Example 4, wherein, to perform the request, the processing circuitry is configured to: access an array of physical block addresses from the node; and perform the operation on all physical block references at indices of the array between a first index corresponding to the physical block and a second index equal to the first index plus the length.

In Example 6, the subject matter of any of Examples 1-5, wherein the node identifier includes a file system ID.

In Example 7, the subject matter of Example 6, wherein the node identifier is a concatenation of the file system ID and an inode ID of the file system.

In Example 8, the subject matter of any of Examples 1-7, wherein the node identifier is a Universally Unique Identifier (UUID).

In Example 9, the subject matter of any of Examples 1-8, wherein the processing circuitry is configured to: receive, via the interface, a second request to write to the memory device, the second request including a second node identifier; detect that the memory device does not have a second node that corresponds to the second node identifier; allocate a set of physical blocks based on the second request; create the second node including: storing addresses for the set of physical blocks in an array of the second node; and recording an association between the second node and the second node identifier; and write data to the set of physical blocks to perform the request.

In Example 10, the subject matter of Example 9, wherein, to allocate the set of physical blocks, the processing circuitry is configured to apply a constraint for members of the set of blocks to be contiguous in the memory device.

In Example 11, the subject matter of any of Examples 9-10, wherein the second node identifier is allocated sequentially.

In Example 12, the subject matter of any of Examples 1-11, wherein the request includes a type of write.

In Example 13, the subject matter of Example 12, wherein the type of write is “TEMPORARY,” and wherein, to perform the operation, the processing circuitry is configured to restrict the physical block to a buffer area of the memory device.

In Example 14, the subject matter of any of Examples 1-13, wherein the processing circuitry is configured to: detect a trigger to perform a garbage collection operation on storage of the memory device including the physical block; access an array of physical block addresses from the node; allocate a set of physical blocks with a constraint for members of the set of physical blocks to be contiguous in the memory device; write data from physical blocks corresponding to the physical block addresses to the set of physical blocks; and update the array of physical block addresses with addresses corresponding to the set of physical blocks.

Example 15 is a method for node based addressing in a memory device, the method comprising: receiving, via an interface of a controller of the memory device, a request to perform an operation on data of the memory device, the request including a node identifier; accessing, by processing circuitry of the controller, a node based on the node identifier in the request; identifying a physical block in the memory device from a reference to the physical block in the node; and performing the operation using the physical block as identified from the node.

In Example 16, the subject matter of Example 15, wherein the request includes an offset.

In Example 17, the subject matter of Example 16, wherein identifying the physical block includes: accessing an array of physical block addresses from the node; and reading an address of the physical block at an index of the array corresponding to the offset.

In Example 18, the subject matter of any of Examples 15-17, wherein the request includes a length.

In Example 19, the subject matter of Example 18, wherein performing the request includes: accessing an array of physical block addresses from the node; and performing the operation on all physical block references at indices of the array between a first index corresponding to the physical block and a second index equal to the first index plus the length.

In Example 20, the subject matter of any of Examples 15-19, wherein the node identifier includes a file system ID.

In Example 21, the subject matter of Example 20, wherein the node identifier is a concatenation of the file system ID and an inode ID of the file system.

In Example 22, the subject matter of any of Examples 15-21, wherein the node identifier is a Universally Unique Identifier (UUID).

In Example 23, the subject matter of any of Examples 15-22, comprising: receiving, via the interface of the controller of the memory device, a second request to write to the memory device, the second request including a second node identifier; detecting that the memory device does not have a second node that corresponds to the second node identifier; allocating a set of physical blocks based on the second request; creating the second node including: storing addresses for the set of physical blocks in an array of the second node; and recording an association between the second node and the second node identifier; and writing data to the set of physical blocks to perform the request.

In Example 24, the subject matter of Example 23, wherein allocating the set of physical blocks includes applying a constraint for members of the set of blocks to be contiguous in the memory device.

In Example 25, the subject matter of any of Examples 23-24, wherein the second node identifier is allocated sequentially.

In Example 26, the subject matter of any of Examples 15-25, wherein the request includes a type of write.

In Example 27, the subject matter of Example 26, wherein the type of write is “TEMPORARY,” and wherein performing the operation restricts the physical block to a buffer area of the memory device.

In Example 28, the subject matter of any of Examples 15-27, comprising: detecting a trigger to perform a garbage collection operation on storage of the memory device including the physical block; accessing an array of physical block addresses from the node; allocating a set of physical blocks with a constraint for members of the set of physical blocks to be contiguous in the memory device; writing data from physical blocks corresponding to the physical block addresses to the set of physical blocks; and updating the array of physical block addresses with addresses corresponding to the set of physical blocks.

Example 29 is a machine readable medium including instructions for node based addressing in a memory device, the instructions, when executed by processing circuitry of a memory device, cause the processing circuitry to perform operations comprising: receiving, via an interface of the memory device, a request to perform an operation on data of the memory device, the request including a node identifier; accessing, by processing circuitry of the controller, a node based on the node identifier in the request; identifying a physical block in the memory device from a reference to the physical block in the node; and performing the operation using the physical block as identified from the node.

In Example 30, the subject matter of Example 29, wherein the request includes an offset.

In Example 31, the subject matter of Example 30, wherein identifying the physical block includes: accessing an array of physical block addresses from the node; and reading an address of the physical block at an index of the array corresponding to the offset.

In Example 32, the subject matter of any of Examples 29-31, wherein the request includes a length.

In Example 33, the subject matter of Example 32, wherein performing the request includes: accessing an array of physical block addresses from the node; and performing the operation on all physical block references at indices of the array between a first index corresponding to the physical block and a second index equal to the first index plus the length.

In Example 34, the subject matter of any of Examples 29-33, wherein the node identifier includes a file system ID.

In Example 35, the subject matter of Example 34, wherein the node identifier is a concatenation of the file system ID and an inode ID of the file system.

In Example 36, the subject matter of any of Examples 29-35, wherein the node identifier is a Universally Unique Identifier (UUID).

In Example 37, the subject matter of any of Examples 29-36, wherein the operations comprise: receiving, via the interface of the controller of the memory device, a second request to write to the memory device, the second request including a second node identifier; detecting that the memory device does not have a second node that corresponds to the second node identifier; allocating a set of physical blocks based on the second request; creating the second node including: storing addresses for the set of physical blocks in an array of the second node; and recording an association between the second node and the second node identifier; and writing data to the set of physical blocks to perform the request.

In Example 38, the subject matter of Example 37, wherein allocating the set of physical blocks includes applying a constraint for members of the set of blocks to be contiguous in the memory device.

In Example 39, the subject matter of any of Examples 37-38, wherein the second node identifier is allocated sequentially.

In Example 40, the subject matter of any of Examples 29-39, wherein the request includes a type of write.

In Example 41, the subject matter of Example 40, wherein the type of write is “TEMPORARY,” and wherein performing the operation restricts the physical block to a buffer area of the memory device.

In Example 42, the subject matter of any of Examples 29-41, wherein the operations comprise: detecting a trigger to perform a garbage collection operation on storage of the memory device including the physical block; accessing an array of physical block addresses from the node; allocating a set of physical blocks with a constraint for members of the set of physical blocks to be contiguous in the memory device; writing data from physical blocks corresponding to the physical block addresses to the set of physical blocks; and updating the array of physical block addresses with addresses corresponding to the set of physical blocks.

Example 43 is a system for node based addressing in a memory device, the system comprising: means for receiving a request to perform an operation on data of the memory device, the request including a node identifier; means for accessing a node based on the node identifier in the request; means for identifying a physical block in the memory device from a reference to the physical block in the node; and means for performing the operation using the physical block as identified from the node.

In Example 44, the subject matter of Example 43, wherein the request includes an offset.

In Example 45, the subject matter of Example 44, wherein the means for identifying the physical block include: means for accessing an array of physical block addresses from the node; and means for reading an address of the physical block at an index of the array corresponding to the offset.

In Example 46, the subject matter of any of Examples 43-45, wherein the request includes a length.

In Example 47, the subject matter of Example 46, wherein the means for performing the request include: means for accessing an array of physical block addresses from the node; and means for performing the operation on all physical block references at indices of the array between a first index corresponding to the physical block and a second index equal to the first index plus the length.

In Example 48, the subject matter of any of Examples 43-47, wherein the node identifier includes a file system ID.

In Example 49, the subject matter of Example 48, wherein the node identifier is a concatenation of the file system ID and an inode ID of the file system.

In Example 50, the subject matter of any of Examples 43-49, wherein the node identifier is a Universally Unique Identifier (UUID).

In Example 51, the subject matter of any of Examples 43-50, comprising: means for receiving a second request to write to the memory device, the second request including a second node identifier; means for detecting that the memory device does not have a second node that corresponds to the second node identifier; means for allocating a set of physical blocks based on the second request; means for creating the second node including: means for storing addresses for the set of physical blocks in an array of the second node; and means for recording an association between the second node and the second node identifier; and means for writing data to the set of physical blocks to perform the request.

In Example 52, the subject matter of Example 51, wherein the means for allocating the set of physical blocks include means for applying a constraint for members of the set of blocks to be contiguous in the memory device.

In Example 53, the subject matter of any of Examples 51-52, wherein the second node identifier is allocated sequentially.

In Example 54, the subject matter of any of Examples 43-53, wherein the request includes a type of write.

In Example 55, the subject matter of Example 54, wherein the type of write is “TEMPORARY,” and wherein the means for performing the operation restrict the physical block to a buffer area of the memory device.

In Example 56, the subject matter of any of Examples 43-55, comprising: means for detecting a trigger to perform a garbage collection operation on storage of the memory device including the physical block; means for accessing an array of physical block addresses from the node; means for allocating a set of physical blocks with a constraint for members of the set of physical blocks to be contiguous in the memory device; means for writing data from physical blocks corresponding to the physical block addresses to the set of physical blocks; and means for updating the array of physical block addresses with addresses corresponding to the set of physical blocks.

Example 57 is at least one machine-readable medium including instructions that, when executed by processing circuitry, cause the processing circuitry to perform operations to implement of any of Examples 1-56.

Example 58 is an apparatus comprising means to implement of any of Examples 1-56.

Example 59 is a system to implement of any of Examples 1-56.

Example 60 is a method to implement of any of Examples 1-56.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus comprising:
an interface configured to communicate to a device external to the memory device; and
processing circuitry configured, when in operation, to:
receive, via the interface, a request to perform an operation on data of the memory device, the request including a node identifier;
access a node based on the node identifier in the request;
identify a physical block in the memory device from a reference to the physical block in the node; and
perform the operation using the physical block as identified from the node.

2. The apparatus of claim 1, wherein the request includes an offset.

3. The apparatus of claim 2, wherein, to identify the physical block, the processing circuitry is configured to:
access an array of physical block addresses from the node; and
read an address of the physical block at an index of the array corresponding to the offset.

4. The apparatus of claim 1, wherein the request includes a length.

5. The apparatus of claim 4, wherein, to perform the request, the processing circuitry is configured to:
access an array of physical block addresses from the node; and
perform the operation on all physical block references at indices of the array between a first index corresponding to the physical block and a second index equal to the first index plus the length.

6. The apparatus of claim 1, wherein the processing circuitry is configured to:
receive, via the interface, a second request to write to the memory device, the second request including a second node identifier;
detect that the memory device does not have a second node that corresponds to the second node identifier;
allocate a set of physical blocks based on the second request;
create the second node including:
storing addresses for the set of physical blocks in an array of the second node; and
recording an association between the second node and the second node identifier; and
write data to the set of physical blocks to perform the request.

7. A non-transitory machine readable medium including instructions that, when executed by processing circuitry of a memory device, cause the processing circuitry to perform operations comprising:
receiving, via an interface of the memory device, a request to perform an operation on data of the memory device, the request including a node identifier;
accessing a node based on the node identifier in the request;
identifying a physical block in the memory device from a reference to the physical block in the node; and
performing the operation using the physical block as identified from the node.

8. The non-transitory machine readable medium of claim 7, wherein the request includes an offset.

9. The non-transitory machine readable medium of claim 8, wherein identifying the physical block includes:
accessing an array of physical block addresses from the node; and
reading an address of the physical block at an index of the array corresponding to the offset.

10. The non-transitory machine readable medium of claim 7, wherein the request includes a length.

11. The non-transitory machine readable medium of claim 10, wherein performing the request includes:
accessing an array of physical block addresses from the node; and
performing the operation on all physical block references at indices of the array between a first index corresponding to the physical block and a second index equal to the first index plus the length.

12. The non-transitory machine readable medium of claim 7, wherein the node identifier includes a file system ID for a file system.

13. The non-transitory machine readable medium of claim 12, wherein the node identifier is a concatenation of the file system ID and an inode ID of the file system.

14. The non-transitory machine readable medium of claim 7, wherein the node identifier is a Universally Unique Identifier (UUID).

15. The non-transitory machine readable medium of claim 7, wherein the operations comprise:
receiving, via the interface, a second request to write to the memory device, the second request including a second node identifier;
detecting that the memory device does not have a second node that corresponds to the second node identifier;
allocating a set of physical blocks based on the second request;
creating the second node including:
storing addresses for the set of physical blocks in an array of the second node; and
recording an association between the second node and the second node identifier; and
writing data to the set of physical blocks to perform the request.

16. The non-transitory machine readable medium of claim 15, wherein allocating the set of physical blocks includes applying a constraint for members of the set of physical blocks to be contiguous in the memory device.

17. The non-transitory machine readable medium of claim 15, wherein the second node identifier is allocated sequentially.

18. The non-transitory machine readable medium of claim 7, wherein the request includes a type of write.

19. The non-transitory machine readable medium of claim 18, wherein the type of write is “TEMPORARY,” and wherein performing the operation restricts the physical block to a buffer area of the memory device.

20. The non-transitory machine readable medium of claim 7, wherein the operations comprise:
detecting a trigger to perform a garbage collection operation on storage of the memory device including the physical block;
accessing an array of physical block addresses from the node;
allocating a set of physical blocks with a constraint for members of the set of physical blocks to be contiguous in the memory device;
writing data from physical blocks corresponding to the physical block addresses to the set of physical blocks; and
updating the array of physical block addresses with addresses corresponding to the set of physical blocks.
